(19) United States
(12) Patent Application Publication
(10) Pub. No.: US 2013/0284927 A1
(43) Pub. Date: Oct. 31, 2013

(54) INFRARED DETECTOR HAVING AT LEAST ONE SWITCH POSITIONED THEREIN FOR MODULATION AND/OR BYPASS

(71) Applicant: UD Holdings, LLC, Dearborn Heights, MI (US)

(72) Inventor: David Kryskowski, Ann Arbor, MI (US)

(21) Appl. No.: 13/859,949

(22) Filed: Apr. 10, 2013

Related U.S. Application Data
(60) Provisional application No. 61/622,388, filed on Apr. 10, 2012.

(51) Int. Cl. G01J 5/10

(52) U.S. Cl. CPC G01J 5/10
USPC 250/338.1

(57) ABSTRACT

In at least one embodiment, a sensing apparatus is provided. The sensing apparatus comprises a substrate, a thermopile, and a readout circuit. The thermopile includes an absorber positioned above the substrate for receiving thermal energy and for generating an electrical output indicative of the thermal energy. The readout circuit is positioned below the absorber and includes at least one first switch positioned therein for being electrically coupled to the thermopile to provide a bypass in the event the thermopile is damaged.

### CROSS-REFERENCE TO RELATED APPLICATIONS

This application claims the benefit of U.S. provisional Application No. 61/622,388 filed Apr. 10, 2012, the disclosure of which is incorporated in its entirety by reference herein.

### TECHNICAL FIELD

Embodiments of the present disclosure generally relate to, among other things, an infrared (IR) detector.

### BACKGROUND

An IR detector is generally defined as a photodetector that responds to IR radiation. One type of an infrared detector is a thermal based detector. A thermal based detector may be implemented within a camera to generate an image of an object formed on the thermal properties generally associated with such an object. Thermal based detectors are known to include bolometers, microbolometers, pyroelectric, and thermopiles.

A microbolometer changes its electrical resistance based on an amount of radiant energy that is received from an object. Thermopiles include a number of thermocouples that convert thermal energy from the object into electrical energy. Such devices have been incorporated into cameras in one form or another for thermal imaging purposes.

### SUMMARY

In at least one embodiment, a sensing apparatus is provided. The sensing apparatus comprises a substrate, a thermopile, and a readout circuit. The thermopile includes an absorber positioned above the substrate for receiving thermal energy and for generating an electrical output indicative of the thermal energy. The readout circuit is positioned below the absorber and includes at least one first switch positioned therein for being electrically coupled to the thermopile to provide a bypass in the event the thermopile is damaged.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 depicts a conventional microbolometer based detector;

FIG. 2 depicts a conventional thermopile based detector;

FIG. 3 depicts an IR detector in accordance to one embodiment of the present disclosure;

FIG. 4 depicts a function generator implemented within the IR detector of FIG. 3 in accordance to one embodiment;

FIG. 5 depicts a thermopile array implemented within the IR detector of FIG. 3 in accordance to one embodiment;

FIG. 6 depicts another thermopile array implemented within the IR detector of FIG. 3 in accordance to one embodiment;

FIG. 7 depicts another IR detector in accordance to one embodiment;

FIG. 8 depicts a thermopile array implemented within the IR detector of FIG. 7 in accordance to one embodiment;

FIG. 9 depicts a thermopile and switching arrangement for a voltage summing configuration in accordance to one embodiment;

FIG. 10 depicts another thermopile and switching arrangement for the voltage summing configuration in accordance to one embodiment;

FIG. 11 depicts another thermopile and switching arrangement for the voltage summing configuration in accordance to one embodiment;

FIG. 12 depicts a thermopile and switching arrangement for a current summing configuration in accordance to one embodiment;

FIG. 13 depicts another thermopile and switching arrangement for a current summing configuration in accordance to one embodiment;

FIG. 14 depicts another thermopile and switching arrangement for the current summing configuration in accordance to one embodiment;

FIG. 15 depicts an elevated view of a thermal detector in accordance to one embodiment; and

FIG. 16 depicts a cross-sectional view of the thermal detector of FIG. 15 in accordance to one embodiment.

### DETAILED DESCRIPTION

Detailed embodiments are disclosed herein. However, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the one or more embodiments of the present disclosure.

Various embodiments disclose herein generally provide for, but not limited to, an IR detector that includes a thermal sensing device based array. The array includes a plurality of thermal sensing elements that each include a thermopile (or other suitable thermal sensing device) distributed into M columns and N rows (e.g., M×N thermopile array). A function generator (or other suitable device that is situated to generate an oscillating signal at a corresponding frequency) may drive each column (or row) of thermal sensing elements (to modulate an output of each thermopile) within the array with oscillating signals at a different frequency from one another such that an electrical output is provided for each column (or row). The modulated electrical output from each thermopile in the column (or row) may be provided on a single modulated electrical output and is amplified by an amplifier (or other suitable device) for the given column (or row). A demodulation circuit may receive each single modulated electrical output after amplification for each column (or row) and demodulate the amplified output (e.g., remove constant value from oscillating signal(s) for each column (or row)) to generate a constant electrical value. The constant electrical value may be indicative of a portion of the entire the detected image. The entire detected image can be reconstructed by assembling all of the constant electrical values that are read from each column (or row) within the array. It is recognized that it may not be necessary to drive all thermal sensing elements in every row and column in the array and that selected clusters of the thermal sensing elements in a corresponding column (or row) may be driven with oscillating signals at a different frequency from one another. This condition may reduce cost of the IR detector in the event some degree of performance sacrifice may be acceptable.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein.

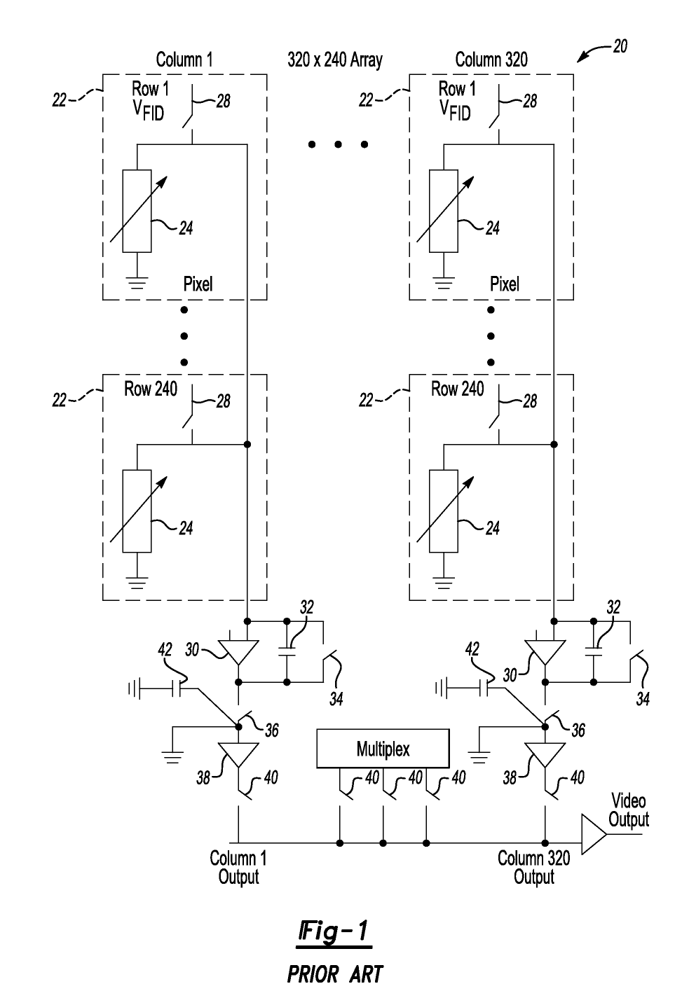

FIG. 1 depicts a conventional microbolometer based detector 20. The detector 20 may be implemented within a camera. The detector 20 may comprise a plurality of pixels 22 that are arranged in 320×240 array (e.g., 320 columns and 240 rows). Each pixel 22 includes a microbolometer 24, and a switch 28. The switch 28 may be implemented as a field effect transistor (FET). It is known that the microbolometers 24 and the switches 28, are formed on a semiconductor substrate. The detector 20 may be implemented with a pixel pitch of 45 um using a 3.3V 0.5 um Complementary Metal-Oxide Semiconductor (CMOS) technology.

A selectable DC based power supply (not shown) closes the switches 28 in sequence, row by row (e.g., all switches in a row are closed at the same time while all other switches in different rows are open) so that current from one microbolometer 24 in a column flows therefrom. The condition of measuring a single bolometer in a time slice that is 1/N (where N corresponds to the number of rows) before the cycle repeats is generally defined as time division multiplexing (TDM).

A capacitive trans-impedance amplifier (CTIA) 30 is coupled to the output of each pixel 22 for a given column. A capacitor 32 is coupled to each CTIA 30. The size of the capacitor 32 controls the gain of the CTIA 30 output. Each CTIA 30 performs a current-voltage conversion by integrating a charge on the capacitor 32. A switch 34 may serve to reset the current to voltage conversion performed by the CTIA 30.

A switch 36 and capacitor 42 are coupled to an output of the CTIA 30 to perform a sample and hold (S&H) operation for a given column. When the proper amount of charge is integrated across the capacitor 32, the switch 36 closes momentarily to transfer the charge to the capacitor 42. The purpose of S&H operation is to hold the charge collected from the capacitor 32 to await digitization.

An additional amplifier 38 and switch 40 is provided so that the output from each column can be read. The switch 40 can be configured to close to enable the output for corresponding column to pass through a multiplexer. Once the output for a given column is ascertained, the switches 28 and 40 are opened and the switches 28 and 40 for a preceding row are closed so that a reading for such a row can be ascertained. This sequence occurs one at time for every row within the array. As noted above, the detector 20 employs a TDM approach such that the FET switch 28 for a given row is closed one at a time so that the corresponding output for the given row is ascertained. The outputs for each column are transmitted on a signal VIDEO_OUTPUT to an Analog to Digital (A/D) converter (not shown). The detector 20 as used in connection with the TDM approach may exhibit noise aliasing.

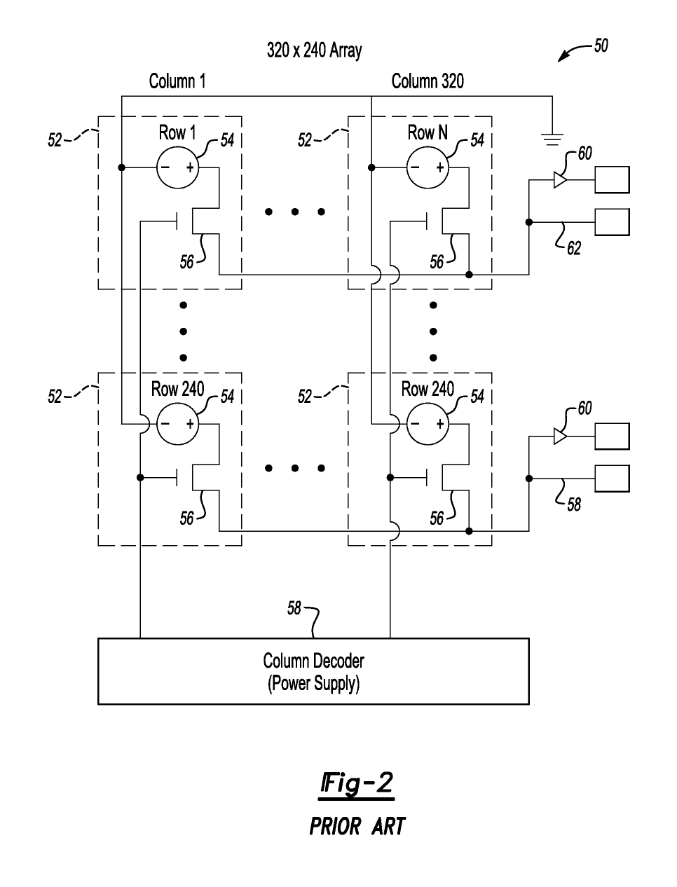

FIG. 2 depicts a conventional thermopile based detector 50. The detector 50 may be implemented within a camera. The detector 50 is generally packaged, mounted on a circuit board and enclosed by a cap in which a lens is arranged. The detector 50 includes a plurality of pixels 52 that may be arranged in 320×240 array (e.g., 320 columns and 240 rows). Each pixel 52 includes a thermopile sensor element 54 and a switch 56. The switch 56 is implemented as a FET.

A column decoder 58 is provided and includes a DC power supply that selectively closes the switches 56 on a column wise bases, one column at a time (i.e., the detector 50 employs a TDM scheme). Each thermopile 54 in the corresponding column generates an output voltage in response to the switch 56 being closed. A low noise amplifier 60 is operably coupled to each thermopile 54 in a given row. The amplifier 60 is generally configured to provide a higher output gain than that of the amplifier used in connection with the detector 20 (e.g., the microbolometer based detector). A representative amplifier that may be used for increasing the gain from the thermopiles 54 is an LT6014 that is provided by Linear Technology of 1630 McCarthy Blvd., Milpitas, Calif. 95035-7417. A lead 62 is provided for distributing the output voltage from the thermopile 54 to a device that is not included within the detector 50. The amplifier 56 increases the output voltage provided from the thermopile 54.

In general, after each thermopile 54 within a given column is enabled by a corresponding FET switch 56, each amplifier 60 that is coupled to the thermopile 54 requires a settling time. After such a settling time is achieved, the voltage output provided by the thermopile 54 is digitized so that the image can be rendered as an electronic image.

It is known that thermopiles generally have a good signal-to-noise ratio. It is also known that thermopiles generally exhibit a low response and low noise. In order to increase the response, the low noise amplifier 60 may be needed to increase the gain for a particular row of pixels 52. However, the use of such low noise amplifiers may still add a significant amount of noise in the detector 50 readout. Particularly, for amplifiers that are incorporated on the same silicon substrate as the detector 50.

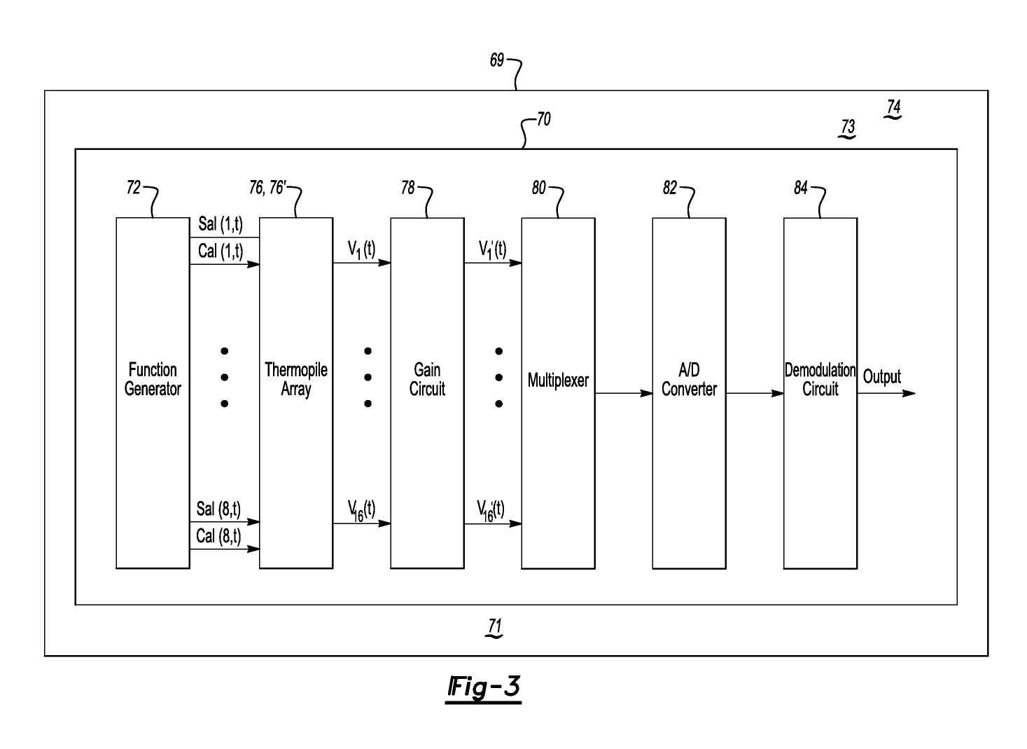

FIG. 3 depicts a thermopile IR detector 70 in accordance to one embodiment of the present disclosure. The detector 70 may be implemented within an imaging device 69 such as, but not limited to, a camera. The detector 70 is generally put into a package and mounted on a circuit board 71. The detector 70 and the circuit board 71 are enclosed by a cap 73 in which a lens 74 is arranged. The detector 70 generally comprises a function generator 72 and a thermopile array 76 or 76′. The function generator 72 may drive each column (or row) of the thermopiles at the same time with an oscillating carrier (or oscillating signal). Each thermopile generates an electrical output in response to the thermal energy captured from the object. The corresponding electrical output that is generated by the thermopile is amplitude modulated with the oscillating carrier signal and transmitted therefrom. Each column (or row) of thermopiles is driven at a unique frequency from one another. In general, the function generator 72 is configured to activate all of the thermopiles in all of the columns (or rows) to amplitude modulate the output from each thermopile (e.g., through the use of one or more switches that may be coupled to each thermopile) with the oscillating carrier which is at a unique frequency for each column (or row). All of the thermopiles may be active at the same time. A gain circuit 78 that includes a plurality of amplifiers is operably coupled to the thermopile array 76 or 76′. Each amplifier is coupled to a particular column (or row) of thermopiles to increase the signal strength for each column (or row) of thermopiles. A demodulation circuit 84 is generally coupled to the gain circuit 78 and is configured to separate the orthogonal carriers for each column (or row) of thermopiles so that the corresponding voltage (or current) output from each column of thermopiles can be ascertained in order to generate an electronic image of the captured original image. It is contemplated that the embodiments of the present disclosure may utilize frequency modulation or phase modulation. Any reference to a thermopile being in a row may also apply to such thermopile being in a column.

The concept of modulating all of the thermopiles for all columns (or rows) with an oscillating carrier at a unique frequency for each column in which all of the carriers are simultaneously presented to each column (or row) and modulated within an array is generally defined as a Frequency Division Multiplexing (FDM) approach. The FDM approach enables the use of a dedicated amplifier to be added to every row in the thermopile array 76 or array 76′ to increase the signal strength irrespective of the amount of noise generated by such amplifier. For example, a natural consequence of amplitude modulating each of the thermopiles for a given column (or row) with a unique carrier signal at a predetermined frequency and then simultaneously presenting such signals to the amplifiers with the gain circuit 78 is that the broadband noise of the channel becomes large (e.g., a standard deviation of the broadband noise grows by the square root of the number of thermopiles on the column (or row)). If the broadband channel noise is “large” compared to the broadband amplifier noise, the broadband noise created by the amplifier on the given column (or row) becomes insignificant due to the fact that the broadband noise for both the channel and the amplifier adds up as a quadrature sum (e.g., square root of the sum of squares of the noise standard deviations) so the amount of noise introduced by the electronics is considered to be inconsequential.

It is also contemplated that the materials used to construct the thermopiles in the array 76 or 76′ may comprise compounds in the (Bi₁₋ₓSbₓ)₂ (Te_{1-y}Se_{y})₃ family (e.g., Bismuth-Tellurium family). The family of compounds will be denoted by Bi₂Te₃ for brevity. The use of Bi₂Te₃ to construct the thermopiles in the array 76 or 76′ may cause the thermopile resistance to fall below 10 K Ohms, which can cause a decrease in the amount of thermopile (or detector) noise. While Bi₂Te₃ based materials can be used to construct thermopiles for the TDM approach to reduce thermopile noise, such a reduction in noise may be minimized when compared to the amount of noise created by the amplifier (e.g., see amplifier 60 in FIG. 2). The large amount of noise created by the amplifier may be mitigated due in large part to the implementation of the FDM approach for the reasons noted above.

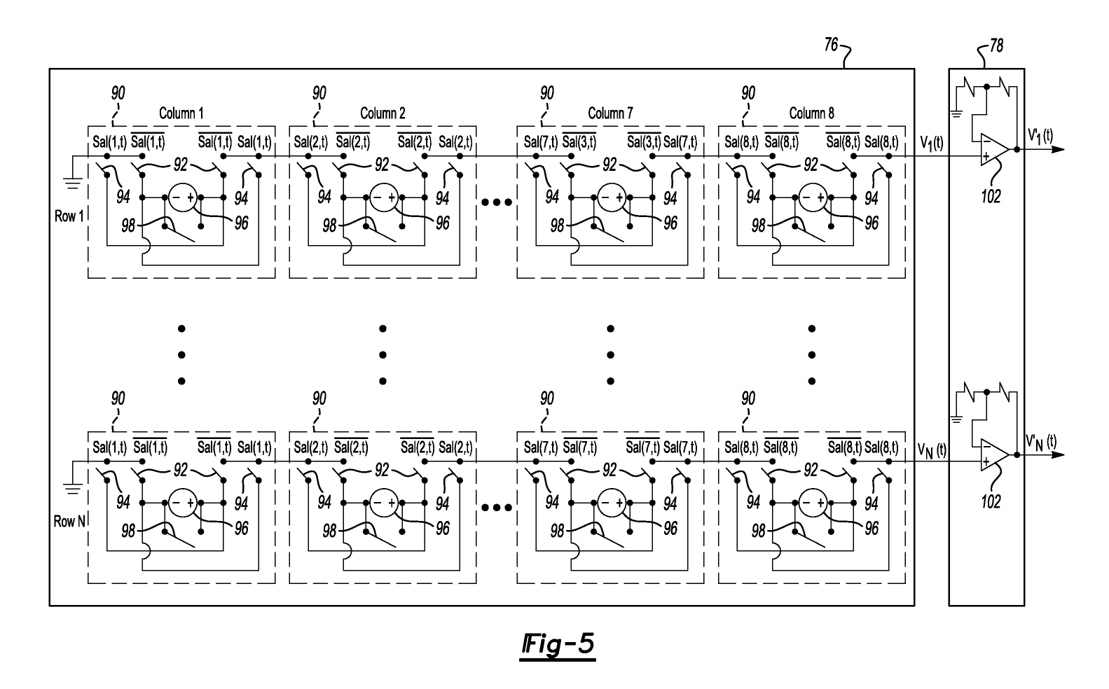

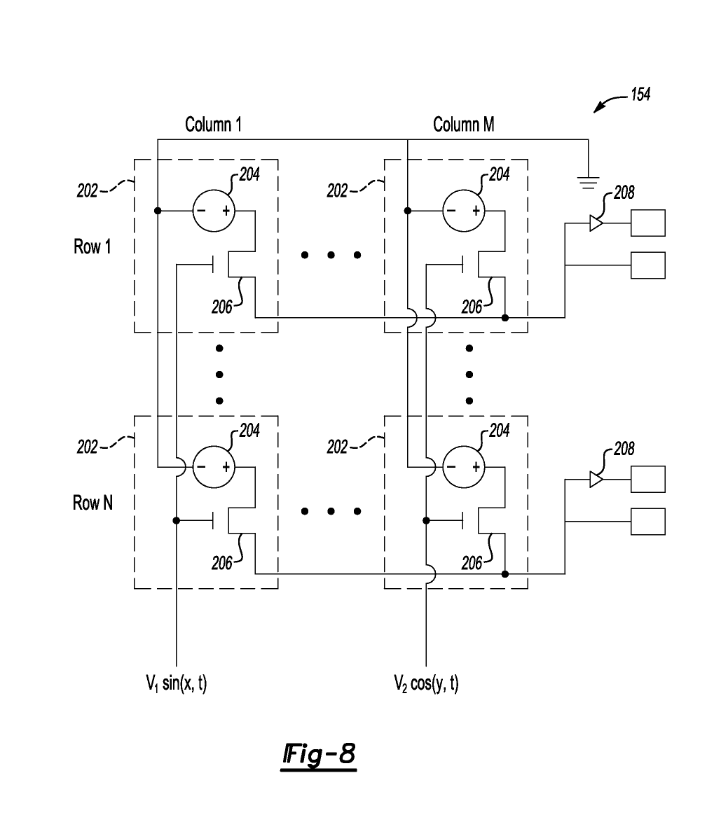

In general, the use of Bi₂Te₃ may produce a very high performance thermopile based detector if the amplifier was ideal with no noise. Because the impedance (or resistance) of a Bi2Te3 based thermopile is so low, its noise is also low. To read out a low impedance thermopile and not add any noise to the output signal may require a very low noise amplifier. This may be an issue with the TDM approach as it may be necessary to read out a high performance thermopile with a very high performance amplifier. High performance may mean high power because the noise from the amplifier is reduced the more power the input stage of the amplifier consumes. On the other hand, the FDM approach may incorporate low impedance (e.g., high performance) thermopiles that are in series (see FIG. 5) to increase the overall noise presented to the amplifier. Since the total noise standard deviation is computed by the square root of the sum of the squares of the thermopile standard deviation (all in parallel or series (see FIGS. 5 and 8)) and the amplifier standard deviation, the total noise may be primarily dominated by the noise from the thermopiles. While the overall signal before demodulation may be noisy, such a noisy signal may be averaged (e.g., by integrating) over a much longer time (e.g., the image frame rate time). Because the overall signal can be integrated over this longer period of time, the signal can be built back to the noise ratio of a single thermopile detector close to its original value after demodulation and the influence of the amplifier noise can be shown to nearly vanish. This condition may illustrate the notion of predicting the noise and using measures within the design to eliminate its effects.

It is further recognized that the materials used to construct the thermopile in the array 76 or 76′ may comprise superlattice quantum well materials as set forth in co-pending application Serial No. PCT/US2011/55220, (“the '520 application”), entitled “SUPERLATTICE QUANTUM WELL INFRARED DETECTOR” filed on Oct. 7, 2011, which is hereby incorporated by reference in its entirety.

The following illustrates the manner in which the FDM approach may reduce the electronic noise in comparison to the TDM approach. In particular, the signal to noise (SNR) ratio will be computed for the TDM approach and the FDM approach. The signal from a ith detector (thermopile) under TDM can be written as:

rᵢ(t)=vₛᵢ+n_{d}(t)+nₑ(t) (1)

where:
rᵢ(t)=Received signal from iₜₕ detector
vₛᵢ=Signal voltage from iₜₕ detector (V)
n_{d}(t)=zero-mean white Gaussian detector noise with spectral height

$${v}_{d}^{2} ( \frac{{V}^{2}}{Hz} )$$

nₑ(t)=zero-mean white Gaussian electronics noise with spectral height

$${v}_{e}^{2} ( \frac{{V}^{2}}{Hz} )$$

E[n_{d}(t)nₑ(t)]=0
E[•]=statistical expectation
Var[•]=statistical variance
In the TDM approach, the detector is sampled for a fraction of the frame time, T_{frame}. The fraction of time is determined based on the number of detectors in a row that need to be multiplexed out, N_{column}. The output of a standard integrator is:

$${V}_{TDM} = {\int }_{0}^{\frac{{T}_{frame}}{{N}_{column}}} {r}_{i} ( t ) d t \qquad ( 2 )$$

The SNR is given by the following equation:

$${SNR}_{TDM}^{2} = \frac{{\int }_{0}^{\frac{{T}_{frame}}{{N}_{column}}} {E [ {r}_{i} ( t ) ]}^{2} d t}{Var [ {V}_{TDM} ]} \qquad ( 3 )$$

The SNR for TDM can now be evaluated:

$${SNR}_{TDM}^{2} = \frac{{v}_{{s}_{i}}^{2} \cdot {T}_{frame}}{{N}_{column} ( {v}_{d}^{2} + {v}_{e}^{2} )} \qquad ( 4 )$$

For the FDM approach, each detector is modulated on a unique orthogonal carrier, si(t). It will be shown later that for the FDM approach, all of the detectors are present all the time on the row bus. The consequence of this is that the noise variances of each detector are added together. The signal on the row bus becomes:

r(t)=Σᵤ₌₁^{N}^{_{columns}}[vₛ_{ᵢ}sᵢ(t)]n′_{d}(t)+nₑ(t) (5)

where:
r(t)=Received signal
sᵢ(t)=Orthogonal carrier i
vₛ_{ᵢ}=Thermopile signal or orthogonal carrier i (V)
n′_{d}(t)=zero-mean white Gaussian detector noise with spectral height

$${N}_{columns} \cdot {v}_{d}^{2} ( \frac{{V}^{2}}{Hz} )$$

n′ₑ(t)=zero-mean white Gaussian electronics noise with spectral height

$${v}_{e}^{2} ( \frac{{V}^{2}}{Hz} )$$

E[n_{d}(t)nₑ(t)]=0
and

$$\{ \begin{matrix}{\int }_{0}^{{T}_{frame}} {s}_{i} ( t ) {s}_{j} ( t ) d t = {T}_{frame} & for i = j \\ {\int }_{0}^{{T}_{frame}} {s}_{i} ( t ) {s}_{j} ( t ) d t = 0 & for i \neq j\end{matrix} \qquad ( 6 )$$

In FDM approach, the detector is sampled for the full frame time, T_{frame} because all the detectors are on all the time. The output of a standard integrator is:

V_{FDM}=∫₀^{T}^{_{frame}}r(t)sᵢ(t)dt (7)

The SNR for FDM can now be evaluated for the i^{th} component:

$$\{ \begin{matrix}{SNR}_{FDM}^{2} = \frac{{\int }_{0}^{{T}_{frame}} {E [ {r}_{i} ( t ) ]}^{2} d t}{Var [ {V}_{FDM} ]} \\ = \frac{{v}_{{s}_{i}}^{2} \cdot {T}_{frame}}{( {N}_{column} {v}_{d}^{2} + {v}_{e}^{2} )} \\ = \frac{{v}_{{s}_{i}}^{2} \cdot {T}_{frame}}{{N}_{column} ( {v}_{d}^{2} + \frac{{v}_{e}^{2}}{{N}_{column}} )}\end{matrix} \qquad ( 8 )$$

Comparing Equation 8 to Equation 4, it can be seen that with the FDM approach, the electronic noise variance decreases based on the number of detectors that are multiplexed out (e.g., N_{column}.).

In general, it is recognized that the oscillating carriers may include any orthogonal set of functions such as, but not limited to, Walsh Functions, sine and cosine functions.

The Walsh functions as used herein may be denoted by wal(0, θ), sal(i, θ), sal(i, θ)′, cal(i, θ), and/or cal(i, θ)′ (where θ is normalized time t/T). Walsh functions may generally form a complete system of orthonormal functions, which may be similar to the system of sine and cosine functions. There is a close connection between sal and sine functions, as well as between cal and cosine functions. In general, Walsh functions are known to form a complete orthonormal set and are therefore orthogonal.

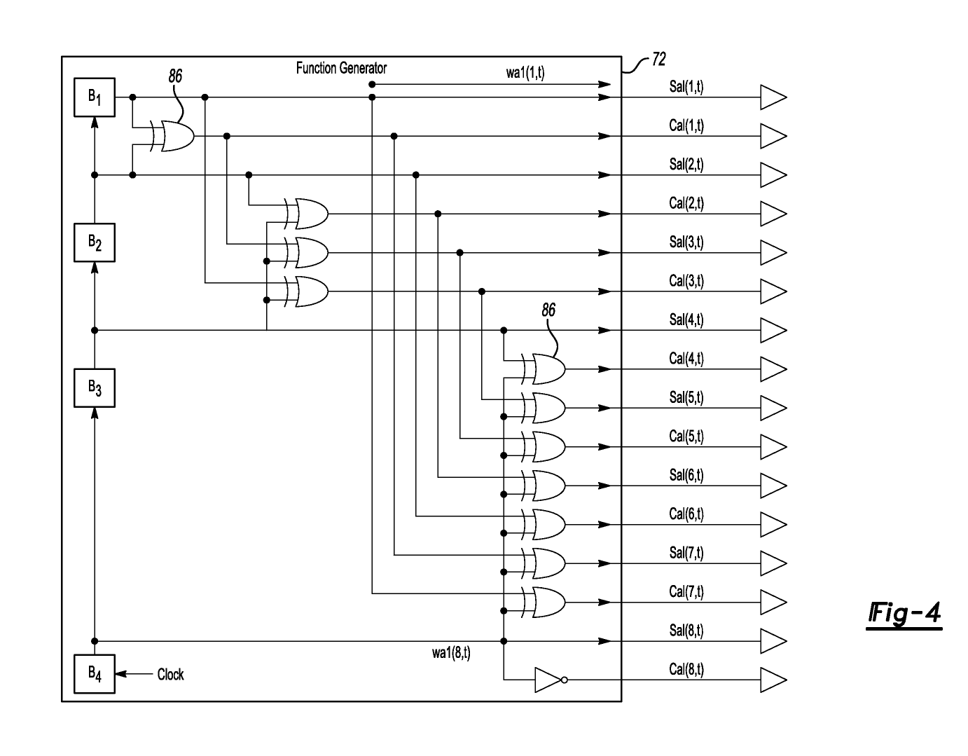

FIG. 4 depicts a function generator 72 implemented within the detector 70 of FIG. 3 in accordance to one embodiment of the present disclosure. The function generator 72 is configured to generate Walsh functions such as sal(x, t) and cal(y, t). For example, the function generator 72 generates the functions sal(1, t) through sal(8, t) and cal(1, t) through cal(8, t). In one example, the function generator 72 may be a 4-bit synchronous counter. It is recognized that the function generator 72 may be configured to accommodate for any number of bits and that the number of bits selected generally depends on the size (e.g., number of columns and/or rows) of the thermopile array. In addition, it is further recognized that the function generator 72 may be non-synchronous.

The function generator 72 includes a plurality of exclusive-or (XOR) gates 86 for receiving one or more bits (e.g., 4 bits) to generate the functions sal(1, t)-sal(8, t) and the functions cal(1, t)-cal (7, t). In general, the arrangement of the XOR gates 86 and the clock are configured such that each function of sal (x, t) and cal (y, t) is transmitted at a different period from one another so that a predetermined frequency is maintained between each function of sal(x, t) and cal(y, t). Each function of sal(x,t) and cal(y,t) is transmitted to a different column within the array 76. For example, sal(1,t) and cal(1,t) may be transmitted to a first column of thermopiles within the array and so on, in which sal(8,t) and cal(8,t) are transmitted to an eight column within the array 76. Because each function of sal (x, t) and cal (y, t) may be transmitted at a different period from one another to maintain a predetermined frequency therebetween, such a condition may ensure that every column of thermopiles are modulated by the orthogonal set (e.g., of sal and/or cal functions) at a unique frequency.

It is recognized that the function generator 72 may be modified or changed to provide any number of Walsh functions (e.g., sal (x, t), sal (x, t)′, cal (y, t), or cal (y, t)′). The particular implementation of the function generator 72 may be modified to provide any sequence of sal (x, t), sal (x, t)′, cal (y, t), or cal (y, t)′ (one or more of these functions (or any combination thereof may be referred to hereafter as Walsh Function(s) or Walsh (x, t), Walsh (x, t)′, Walsh (y, t), or Walsh (y, t)′, etc.)) to the array 76 or 76′ based on the desired criteria of a particular implementation.

FIG. 5 depicts the thermopile array 76 implemented within the detector 70 of FIG. 3 in accordance to one embodiment of the present disclosure. The array 76 of FIG. 5 is shown in a voltage summing configuration. The array 76 includes a plurality of pixels 90 (or thermal sensing elements) that are arranged in a 8×N array. For example, the array 76 includes 8 columns of pixels 90 and any number of rows of pixels 90. Each pixel 90 includes a first pair of switches 92, a second pair of switches 94, a thermopile 96, and a switch 98. It is recognized that the quantity of switches and thermopiles within each pixel may vary based on the desired criteria of a particular implementation. The switches 92 and 94 may coact with the thermopile to modulate the output of thermopile onto the oscillating signals. The columns of pixels 90 are configured to receive the functions sal(1,t)-sal(8, t); and the complement of sal(1,t)-sal(8, t) from a function generator. The Walsh functions as shown in FIG. 5 are examples. Different arrangements of the Walsh functions may be presented to the array 76.

It is recognized that the size of the array may vary and that the number of columns and rows may be selected based on the desired criteria of a particular implementation. It is also recognized that the number and configuration of switches 92, 94 may vary based on the desired criteria of a particular implementation. The use of such functions may vary as well based on the desired criteria of a particular implementation. The circuit as depicted within the array 76 (or elsewhere in the detector 70) is used for illustrative purposes and is not intended to demonstrate that the embodiments of the present disclosure are to be implemented in this manner alone.

As noted above, each Walsh function is transmitted at a unique frequency to each corresponding column of pixels 90 (e.g., column 1 receives a first Walsh function and a second Walsh function at a first frequency, column 2 receives third Walsh function and a fourth Walsh function at a second frequency, column 3 receives a fifth Walsh function and a sixth Walsh function at a third frequency and so on). Each unique frequency may be separated by a predetermined amount to ensure that an output signal from each pixel 90 can be uniquely recovered during demodulation. In one example, the separation frequency may be 30 Hz.

In general, each column of pixels 90 is driven with the Walsh functions and operate at a unique frequency from one another such that a voltage output from each thermopile 96 is read out on a row-wise basis. While each thermopile 96 may be a particular Walsh function, half of the thermopiles 96 on a corresponding row may be in forward direction (+ side on row bus) and the other half of the thermopiles 96 may be in the reverse direction (− side on row bus) due to the cyclical nature of the orthogonal carriers (e.g, the Walsh functions). It is recognized that the voltage output from a given row is usually near ground because half of the thermopiles 96 may be in the forward direction while the remaining half of the thermopiles 96 are in the reverse direction. The overall dynamic range (e.g., the ratio of the highest measurable signal to the lowest measurable signal) is maintained. The Walsh functions provide for non-overlapping clocks for each pixel 90, which enables suitable switching for each pixel 90.

The array 76 transmits the voltage output for each row on the signal v₁(t) through vₙ(t) (where N=the number of rows in the array). A gain circuit 78 includes a plurality of amplifiers 102 that receives the voltage outputs v₁(t)-vₙ(t) and increases the amplitude for such to generate the voltage outputs v₁′(t)-vₙ′(t). In one example, each amplifier 102 may be a CMOS amplifier similar to LMC6022 from National Semiconductor of 2900 Semiconductor Drive, Santa Clara, Calif. 95052. Each amplifier 102 may be integrated on the same silicon substrate as the array 76. It is recognized that the type of amplifier used may vary based on the desired criteria of a particular implementation. As noted above in connection with FIG. 2, thermopiles generally exhibit a low response and require additional gain to increase the output. The thermopiles 96 are connected in series with one another in a given row and the corresponding voltage output is presented to the non-inverting input of the amplifier 102. Due to such an arrangement, the switch 98 is added across each thermopile 96 to permanently close its corresponding pixel in the event the thermopile 96 is damaged. The coupling of the thermopiles 96 in series in a particular row and the presentation of the voltage output form that row to the non-inverting input of the amplifier 102 increases the gain voltage output and reduces the potential for 1/f noise because of the small current flow into the non-inverting input of the amplifier 102.

Referring to FIGS. 3 and 5, a multiplexer 80 receives the output voltages v₁′(t)-vₙ′(t) from the gain circuit 80. An analog to digital (A/D) converter 82 receives an output voltage v₁′(t)-vₙ′(t) over a single wire bus. The A/D converter 82 converts the output voltage v₁′(t)-vₙ′(t) from an analog voltage signal into a digital voltage signal. The A/D converter 82 may include any combination of hardware and software that enables analog to digital conversion.

The demodulation circuit 84 is configured to receive a digital output from the A/D converter 82 for each row in the array 76. The demodulation circuit 84 may be a matched filter, a Fast Walsh Transform or any other suitable circuit that includes any combination of hardware and software to determine the voltage output for a given row of thermopiles 96 in the array 76. The output from the A/D converter 82 comprises a digital representation of the output voltage from a row of thermopiles 96 that is in the form of a constant that is multiplied to the corresponding orthogonal carriers (e.g., the Walsh functions that are transmitted at the unique frequency for each column).

Each of the unique orthogonal carriers includes the thermopile signal information. Multiplying the received signal by sal(i, t) (or cal(i, t)—if cal (i, t) is used, only a sign change will occur) performs the demodulation. The demodulated signal is then averaged to estimate the thermopile signal. The received signal from a row is given by Equation 9:

$$r ( t ) = {\sum }_{i = 1}^{{N}_{column}} [ m ( t ) sal ( i , t ) ] + {v}_{n} ( t ) \qquad ( 9 )$$

Depending on the scene and thermal time constant, m(t) can be considered to be either a constant or a random variable to be estimated. Assuming that the parameter to be estimated is a constant, the optimal estimator is given by:

$${{m}^{⋒}}_{i} = \frac{1}{{T}_{frame}} {\int }_{0}^{{T}_{frame}} r ( t ) sal ( i , t ) d t \qquad ( 10 )$$

where:
\hat{m}ᵢ=Estimated thermopile output signal from the i^{th} detector
Since sal(i, t) is either +1 or −1 implementation in a digital signal processor (DSP) or field-programmable gate array (FPGA) may be simple.

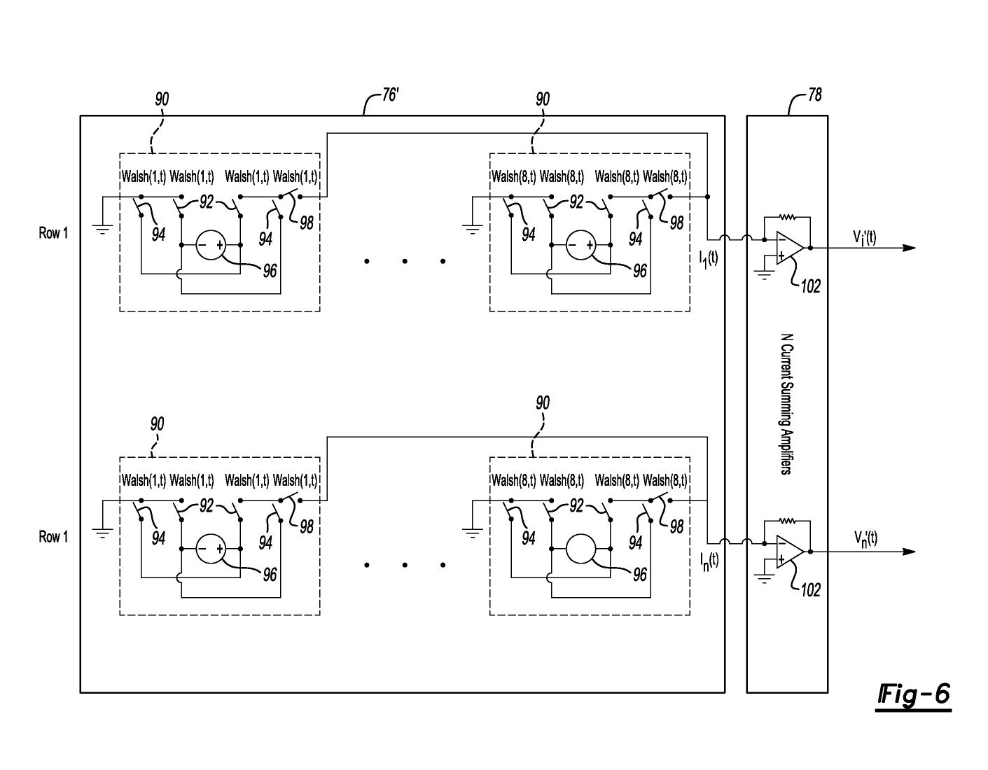

FIG. 6 depicts a thermopile array 76′ implemented with the IR detector of FIG. 3 in accordance to another embodiment of the present disclosure. The array 76′ of FIG. 5 is shown in a current summing configuration. The array 76′ includes the plurality of pixels 90 (or thermal sensing elements) that are arranged in an 8×N array. Each of the thermopiles 90 is in parallel with one another. The array 76′ includes 8 columns of pixels 90 and any number of rows of pixels 90. Each pixel 90 includes the first pair of switches 92, the second pair of switches 94, the thermopile 96, and a switch 98 (or a safety switch). It is recognized that the number of switches and thermopiles within each pixel may vary based on the desired criteria of a particular implementation. In a similar manner to that discussed above in connection with FIG. 5, the switches 92 and 94 may coact with the thermopile to modulate the output of thermopile onto the oscillating signals. The columns of pixels 90 are configured to receive the Walsh functions from a function generator. For example, pixel 90 in column 1 receives a first Walsh function and a second Walsh function; pixel 90 in column 2 receives a third Walsh function and a fourth Walsh function and so on.

It is recognized that the size of the array may vary and that the number of columns and rows may be selected based on the desired criteria of a particular implementation. It is also recognized that the number and configuration of switches 92, 94 may vary based on the desired criteria of a particular implementation. As noted above, each Walsh function is transmitted at a unique frequency to each corresponding column of pixels 90 (e.g., column 1 receives a first Walsh function and a second Walsh function at a first frequency, column 2 receives third Walsh function and a fourth Walsh function at a second frequency, column 3 receives a fifth Walsh function and a sixth Walsh function at a third frequency and so on). Each unique frequency may be separated by a predetermined amount to ensure that an output signal from each pixel 90 can be uniquely recovered during demodulation. In one example, the separation frequency may be 30 Hz.

Similar to the operation noted in the array 76 (e.g., the voltage summing configuration), each column of pixels 90 in the array 76′ is driven by the Walsh functions and operates at a unique frequency from one another such that a current output from each thermopile 96 is read out on a row-wise basis. While each thermopile 96 may be a particular Walsh function, half of the thermopiles 96 on a corresponding row may be in forward direction (+ side on row bus) and the other half of the thermopiles 96 may be in the reverse direction (− side on row bus) due to the cyclical nature of the orthogonal carriers (e.g, sal (x, t), sal (x, t)′, cal (y, t), or cal (y, t)′). It is recognized that the current output from a given row is usually near ground because half of the thermopiles 96 may be in the forward direction while the remaining half of the thermopiles 96 are in the reverse direction. The overall dynamic range (e.g., the ratio of the highest measurable signal to the lowest measurable signal) is maintained. The Walsh functions provide for non-overlapping clocks for each pixel 90, such a condition enables suitable switching for each pixel 90.

The thermopiles 90 in the rows (or columns) may each provide a modulated current output that is indicative of the sensed temperature from the scene. The array 76′ transmits the current output for each row on the signal I₁(t) through Iₙ(t). The gain circuit 78 includes the plurality of amplifiers 102 that receives the current outputs I₁(t)-Iₙ (t) and converts/increases the amplitude for such to generate the voltage outputs V₁′(t)-Vₙ′(t). Each amplifier 102 may be integrated on the same silicon substrate as the array 76 or 76′. As noted above in connection with FIG. 2, thermopiles generally exhibit a low response and require additional gain to increase the output. The thermopiles 96 are connected in parallel with one another in a given row and the corresponding current output is presented to the inverting input of the amplifier 102. The switch 98 is added at an output of the thermopile 96 and in its normal state, is in a closed position to enable current to flow all of the thermopiles 96 in a row (or column) on to the gain circuit 78. In the event the thermopile 96 is damaged, the switch 98 opens to remove the damaged thermopile 96 from the string of thermopiles 96 on a given row or column to enable the remaining thermopiles 96 (on the same column or row) to continue to provide current to the gain circuit 78. It is recognized that with the current summing configuration that the noise attributed to the amplifier and other electronics may be reduced as well. While the coupling of the thermopiles 96 in parallel in a particular row and the presentation of the current output from that row to the inverting input of the amplifier 102 may exhibit an increase which may be much greater than the input noise of the amplifier, the detector signal to noise ratio may be recovered via the longer integration time using FDM and thus dramatically reduce the influence of the amplifier noise (and/or other electronic noise not only from the amplifiers in the gain circuit 78 but elsewhere prior to demodulation).

The operation of the multiplexer 80, the A/D converter 82, and the demodulation circuit 84 as noted used in connection with the array 76′ is similar to that described above for the array 76.

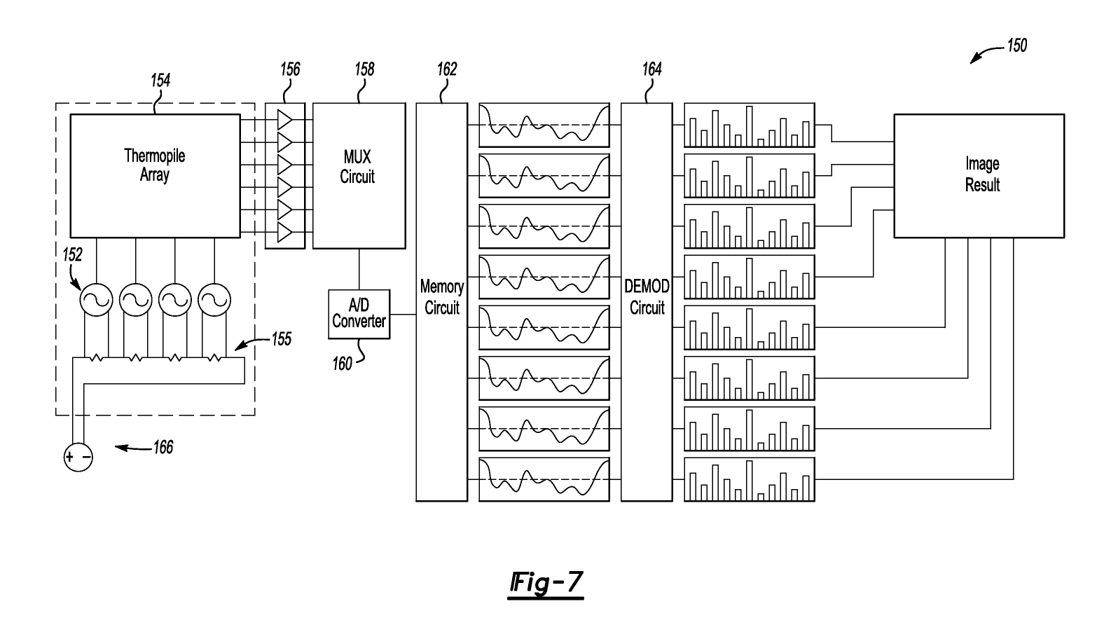

FIG. 7 depicts a thermopile IR detector 150 in accordance to another embodiment of the present disclosure. The detector 150 includes a plurality of oscillators 152 (or function generator), an array 154, a gain circuit 156, a multiplexer circuit 158, an A/D converter 160, a memory circuit 162, and a demodulation circuit 164. The plurality of oscillators 152 is configured to generate oscillating carrier signals at a predetermined frequency for activating all thermopiles within a given column (or row) so that modulated signals are transmitted therefrom. For example, each oscillator 152 is configured to generate an oscillating signal at a unique frequency and to transmit the same to a corresponding column of pixels within the array 154. Each of the columns of pixels is driven at the same time but at different frequency from one another. The detector 150 employs the FDM approach as noted in connection with FIG. 3.

The plurality of oscillators 152 is voltage controlled via a voltage source 166. It is contemplated that different types of oscillators may be used instead of a voltage-controlled oscillator. For example, such oscillators may be coupled to a mechanical resonator (such as, but not limited to, a crystal). The type of device used to generate the oscillating signal at the unique frequency may vary based on the desired criteria of a particular implementation. A plurality of resistors 155 is positioned between the oscillators 152 and the voltage source 166 to adjust the voltage output of the voltage source. The resistance value for each resistor 155 may be selected to ensure such that a different voltage input is provided to each oscillator 152. Such a condition may ensure that the oscillators 152 generate a unique frequency from one another in the event the oscillators 152 are voltage controlled. The oscillators 72 each generate an oscillating signal that is in the form of a sine function (e.g., sin (x, t)) or a cosine function (e.g., cos (y, t)).

FIG. 8 depicts a more detailed diagram of the thermopile array 154. The array 154 is also shown in a current summing configuration. The array 154 includes pixels 202 (or thermal sensing elements) that are arranged in an M×N array. Each pixel 202 includes a thermopile 204 and a FET based switch 206. The number of thermopiles and switches implemented within a given pixel may vary based on the desired criteria of a particular implementation. All of the oscillators 152 are active all of the time such that all of the columns of pixels are amplitude modulated with a unique frequency. For example, the thermopiles 204 in column 1 are driven by a first oscillating signal at a first frequency and the thermopiles 204 in column M are driven by a second oscillating signal at a second frequency, where first frequency is different from the second frequency. In one example, the first frequency may be 30 Hz and the second frequency may be 60 Hz. The particular frequency used for each column is generally defined by:

f(i)=i*30 Hz, (11)

where i corresponds to the column number.

It is recognized that metal film bolometers (or low resistance bolometers) may be implemented instead of the thermopiles with the FDM approach.

As noted in connection with FIGS. 3 and 5, each oscillator 152 is generally configured to activate all of the thermopiles for a corresponding column (or row) with an amplitude modulated orthogonal carrier at a unique frequency so that all of the thermopiles in such a column (or row) are on for the entire frame time. This may be performed for all columns within the array 154. As such, it can be said that all of the thermopiles within the array 154 are active at the same time.

An amplifier 208 may increase the voltage output (or current output) for each row. The multiplexer circuit 158 transmits each voltage output from a row on a single line to the A/D converter 160. The A/D converter 160 converts the voltage output into a digital based output. The A/D converter 160 may include any combination of hardware and software to perform the conversion. A memory circuit 162 stores the digitalized output to enable transfer to the demodulation circuit 164. In one example, the memory circuit 162 may be implemented as a Direct Memory Access (DMA) storage device or other suitable storage mechanism. The demodulation circuit 164 performs a Fast Fourier Transform (FFT) on the digitized output. The demodulation circuit 164 may include any combination of hardware and software to perform the FFT. An image result depicting the captured image is generated therefrom.

It is recognized that thermopile based arrays within the detectors 70 and 150 (or other suitable variants thereof) may exhibit increased levels of thermal stability and thus may be easy to maintain radiometric calibration over a wide range of ambient temperatures. It is also recognized that thermopile based arrays within the detectors 70 and 150 (or other suitable variants thereof) that utilize the FDM approach may be adaptable for a range of capabilities such as, but not limited to, fire fighting applications as such an array may not require special image processing techniques (e.g., combining higher noise low gain images with lower noise high gain images) to display images with both hot and cold objects in the capture image. It is also recognized that thermopile based arrays within the detectors 70 and 150 (or other suitable variants thereof) may respond linearly to incoming radiance from an object. Due to such a linear response, a low cost in-factory radiometric calibration may be achieved. It is also recognized that thermopile output based signals from the thermopiles within the detectors 70 and 150 (or other suitable variants thereof) are generally differential and unbiased and may not exhibit large drift offsets. As such, radiometric calibration may be easier to maintain over a wide range of ambient temperature. It is also recognized that that the detectors 70 and 150 (or other suitable variants thereof) when used in a voltage summing configuration may not exhibit 1/f noise due to the FDM approach, which nearly eliminates the 1/f noise from the amplifier (and/or from additional electronics in the detector) by modulating the output of the thermopile at a high enough frequency where the 1/f noise of the amplifier is negligible. It is also recognized that the detectors 70 and 150 (or other suitable variants thereof) may be able to capture, but not limited to, short temporal events because all of the thermopiles within the array may be capturing energy all of the time.

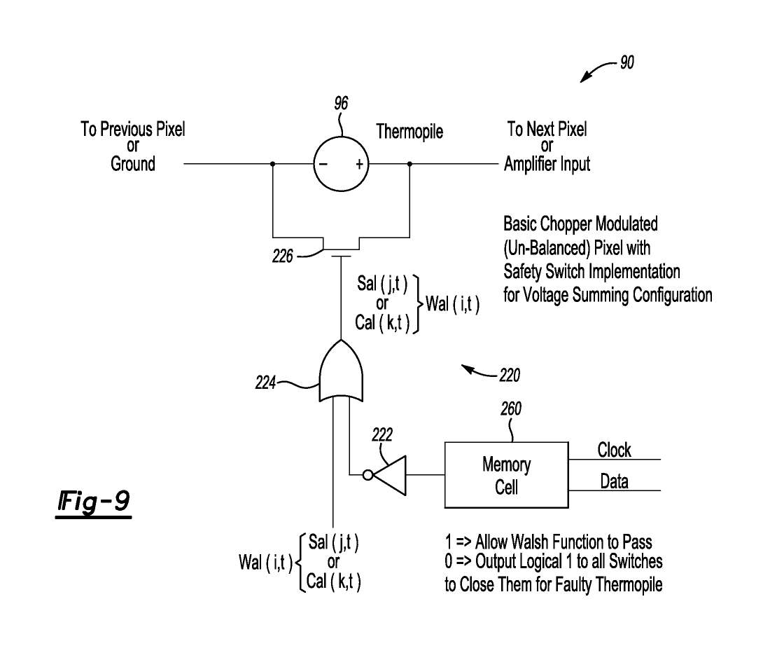

FIG. 9 depicts a thermopile 96 and a switching arrangement 220 for the voltage summing configuration of the array 76 in accordance to one embodiment of the present disclosure. The pixel 90 as depicted in FIG. 9 is generally indicative of a basic chopper modulated (un-balanced) pixel. Because the pixel 90 is a basic chopper modulated pixel, it is active only half of the time.

In general, the following FIGS. 9-14 depict various switching arrangements 220 that may be used in connection with removing a damaged thermopile 96 from a row or column of thermopiles 96 such that the operating thermopiles are free to continue to provide a modulated electrical output therefrom. These figures depict ways in which the damaged thermopile may be bypassed to enable the remaining thermopiles to provide the modulated electrical output.

The switching arrangement 220 includes first logic circuit 222, a second logic circuit 224, and a first switch 226. In one example, the first switch 226 may be implemented as an N-channel MOSFET. In another example, the switches not generally used in an active modulation scheme may be a polysilicon fuse. It is recognized that particular type of switch as disclosed herein may vary based on the desired criteria of a particular implementation.

The first switch 226 may be used to modulate the electric output from the thermopile 96 and may also serve as a safety (or bypass) switch in the event the thermopile is damaged and exhibits a short or open condition due to failure. A memory cell 260 provides data (e.g., binary data (low output “0” or high output “1”)) to the first logic circuit 222. The function generator 72 provides a Walsh functions (e.g., sal (j, t), sal (j, t)′, cal (k,t), and/or cal (k, t)′) to the second logic circuit 224.

For normal operation of the thermopile 96, it may be desirable to allow the Walsh function to modulate on the electrical output of the pixel 90. As such, the memory cell provides high output (e.g., “1”) to the first logic circuit 222. The first logic circuit 222 generates low output (e.g., “0’) in response thereto and the second logic circuit 224 generates high output when the Walsh function exhibits a high output. The first switch 226 is closed enabling the thermopile 96 to provide the modulated electrical output to the next pixel or to the input of the amplifier 102. When the Walsh function exhibits low output, no output is provided by thermopile 96, however a modulated electrical voltage from a previous pixel(s) may be passed through the thermopile 96.

When the thermopile 96 is damaged, it may be desirable in this case to allow the modulated electrical output from the previous pixel to pass through the thermopile to provide the modulated electrical output to the next pixel or to be input of the amplifier 102. If one thermopile 96 in a series of thermopiles 96 in a row or column are damaged in the voltage summing configuration, then such a condition may take out the entire series of thermopiles 96 in the row (or column). Accordingly, the switch 226 serves as a safety bypass. If a particular thermopile 96 is damaged, it is necessary to allow the remaining pixels in the row (column) to provide an output. To account for this condition, the memory cell 260 outputs low output to the first logic circuit 222 when thermopile 96 is detected to be damaged. The first logic circuit 222 generates high output. The second logic circuit 224 provides high output to close the first switch 226. The modulated electrical output from the previous pixel 90 may pass through the first switch 226 and around the damaged thermopile 96 (or bypasses the damaged thermopile 96).

For all noted switching implementations as noted herein, each detector 10 may enable diagnostics such that it is possible to determine which pixel 90 in the array 76, 76′ is damaged. This condition may be performed when the detector 10 is manufactured. For example, after the detector 10 is manufactured, a diagnostic test may be performed to identify which thermopile(s) are damaged. A bad pixel map is generated and populated with data corresponding to the damaged thermopile(s). The various bypass or safety switch can be closed (i.e., for a voltage summing configuration) or opened (i.e., for a current summing configuration) to enable the remaining thermopiles in row or column to provide a modulated electrical output.

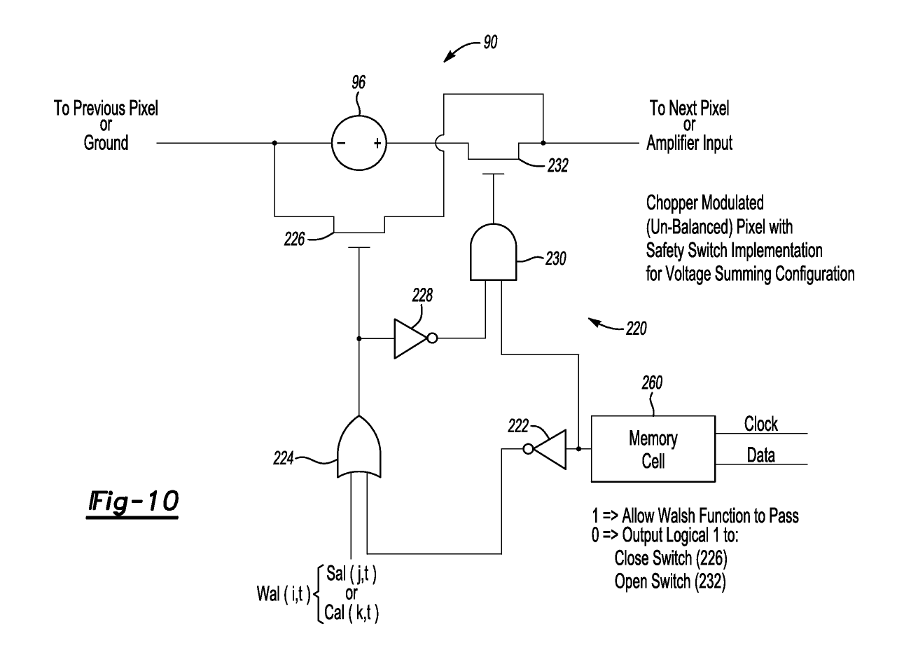

FIG. 10 depicts a thermopile 96 and a switching arrangement 220 for the voltage summing configuration of the array 76 in accordance to one embodiment of the present disclosure. The pixel 90 as depicted in FIG. 10 is also generally indicative of the basic chopper modulated (un-balanced) pixel. The switching arrangement 220 includes the first logic circuit 222, the second logic circuit 224, the first switch 226, a third logic circuit 228, a fourth logic circuit 230, and a second switch 232.

For normal operation of the thermopile 96, the Walsh function is to modulate the electrical output of the pixel 90. In order for the thermopile 96 to provide the modulated electrical output therefrom, the memory cell 260 provides high output and the Walsh function is low output. For example, the second logic circuit 224 generates low output when it receives low output from first logic circuit 222 (e.g., when high output is provided from memory cell 260) and when it receives low output from the Walsh function that is set to zero. The first switch 226 is off based on low output provided from the second logic circuit 224.

The fourth logic circuit 230 receives high output from the memory cell 260 and high output from the third logic circuit 228. The high output from the third logic circuit 228 is generated as a result of memory cell 260 providing high output and Walsh function exhibiting low output. The forth logic circuit 230 generates high output in response to receiving high output from memory cell 260 and third logic circuit 228 thereby activating second switch 232 and allowing modulating electrical output from the thermopile 96.

When the thermopile 96 is damaged, it is necessary for the first switch 226 to be closed and the second switch 232 to be open. When first switch 226 is closed and the second switch 232 is opened, modulated electrical output from previous pixel is routed through the first switch 226 and over the second switch 232 thereby bypassing the thermopile 96 and the second switch 232. To realize the above condition, memory cell 260 provides low output. As such, the second switch 232 is always disabled because the fourth logic circuit 230 outputs low output. On the other hand, the first switch 226 is always enabled (closed) since the first logic circuit 222 and the second logic circuit 224 always provides a high output if the memory cell 260 provides a low output.

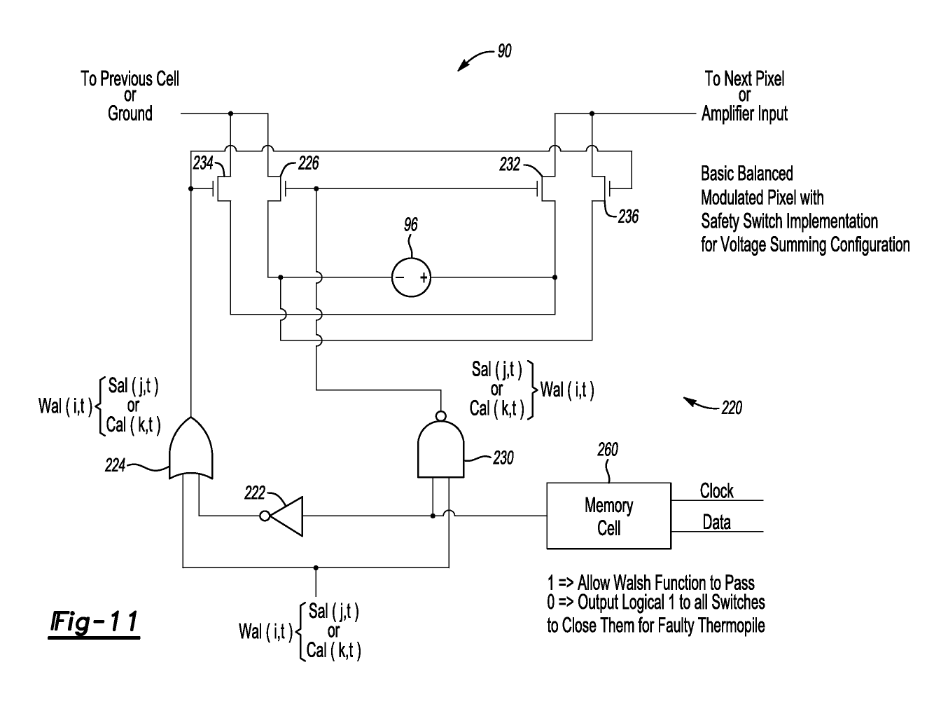

FIG. 11 depicts a thermopile 96 and the switching arrangement 220 for the voltage summing configuration of the array 76 in accordance to one embodiment of the present disclosure. The pixel 90 as depicted in FIG. 11 is also generally indicative of a balanced modulated pixel. Because the pixel 90 is a balanced modulated pixel, it is active all of the time.

The switching arrangement 220 includes the first logic circuit 222, the second logic circuit 224, the fourth logic circuit 230, the first switch 226, the second switch 232, a third switch 234, and a fourth switch 236. For normal operation of the thermopile 96, the Walsh function is to modulate the electrical output of the pixel 90. In order for the thermopile 96 to provide the modulated electrical output therefrom, the memory cell 260 provides a high output and the state of the Walsh function can either be high output or low output. Such a condition enables the thermopile 96 to provide a modulated electrical output irrespective of the state of the Walsh function.

For example, the forth logic circuit 230 receives high output from memory cell 260 and may receive high output from the Walsh function such that a low output is provided therefrom. The first switch 226 and the second switch 232 are open in response to low output from the fourth logic circuit 230. The second logic circuit 224 receives high output from the first logic circuit 222 and produces high output in response thereto. The third switch 234 and the fourth switch 236 are closed in response to high output from the second logic circuit 224. When the third switch 234 and the fourth switch 236 are closed, the thermopile produces a reverse polarity modulated electrical output.

When the Walsh function provides low output, the fourth logic circuit 230 provides high output and the second logic circuit 224 produces low output. The first switch 226 and the second switch 232 are closed in response to high output from the fourth logic circuit 230 and the third switch 234 and the fourth switch 236 are open in response to low output from the second logic circuit 224. When the first switch 226 and the second switch 232 are closed, the thermopile produces a forward polarity modulated electrical output.

When the thermopile 96 is damaged, which may produce an open circuit, it may be necessary for the first switch 226, the second switch 232, the third switch 234 and the fourth switch 236 to be closed to enable the modulated electrical output from a previous pixel to bypass the thermopile 96. To accomplish this, the memory cell 260 provides low output causing the fourth logic circuit 230 to produce a high output (irrespective of state of Walsh function) and the second logic circuit 224 to produce high output (irrespective of state of Walsh function). A high output from the second logic circuit 224 and the fourth logic circuit 230 causes the first switch 226, the second switch 232, the third switch 234, and the fourth switch 236 to close thereby bypassing the thermopile 96.

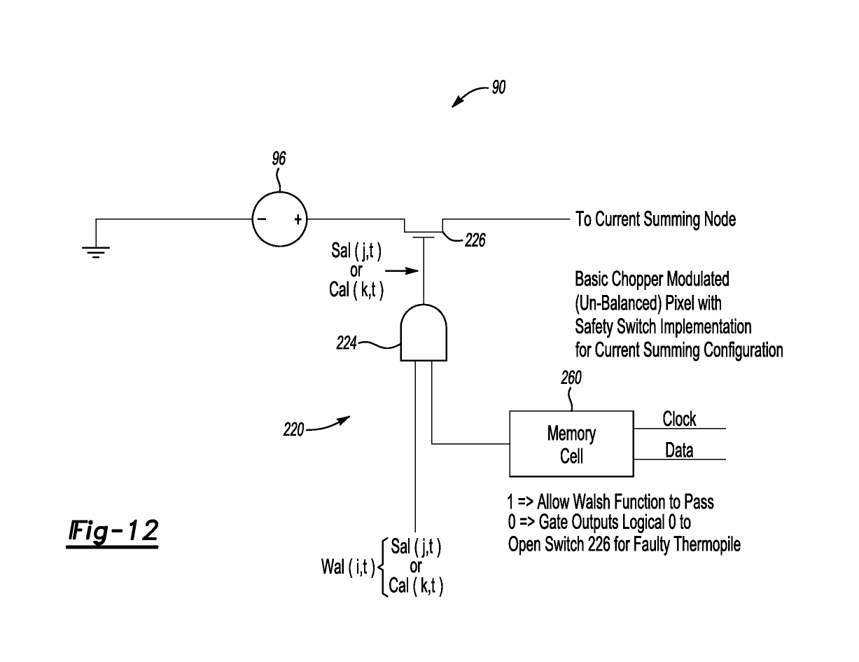

FIG. 12 depicts the thermopile 96 and the switching arrangement 220 for the current summing configuration of the array 76′ in accordance to one embodiment of the present disclosure. The pixel 90 as depicted in FIG. 12 is generally indicative of a chopper modulated unbalanced pixel. Because the pixel 90 is unbalanced, it is active only half of the time.

The switching arrangement 220 includes the second logic circuit 224 and the first switch 226. For normal operation of the thermopile 96, the Walsh function is to be modulated on the electrical output of the pixel 90. In order for the thermopile 96 to provide the modulated electrical output therefrom, the memory cell 260 provides high output and the state of the Walsh function is high output. As shown, the second logic circuit 224 generates high output in response to the memory cell 260 providing high output and the Walsh function being a high output. The first switch 226 closes in response thereto enabling the pixel 90 to produce the modulated electrical output.

When the Walsh function is low output, the second logic circuit 224 produces a low output thereby opening the first switch 226 and preventing the thermopile 96 from providing an electrical output therefrom. In contrast to the voltage summing configuration as noted in connection with FIGS. 9-11, it is necessary to open the switch for a particular pixel 90 that includes a damaged thermopile 96. This condition ensures that pixels positioned in parallel with the damaged thermopile on a given row or column in the array 76′ is capable of still providing a modulated electrical output to the amplifier 102. To open the first switch 226, the memory cell 260 provides low output when the thermopile 96 is detected to be damaged.

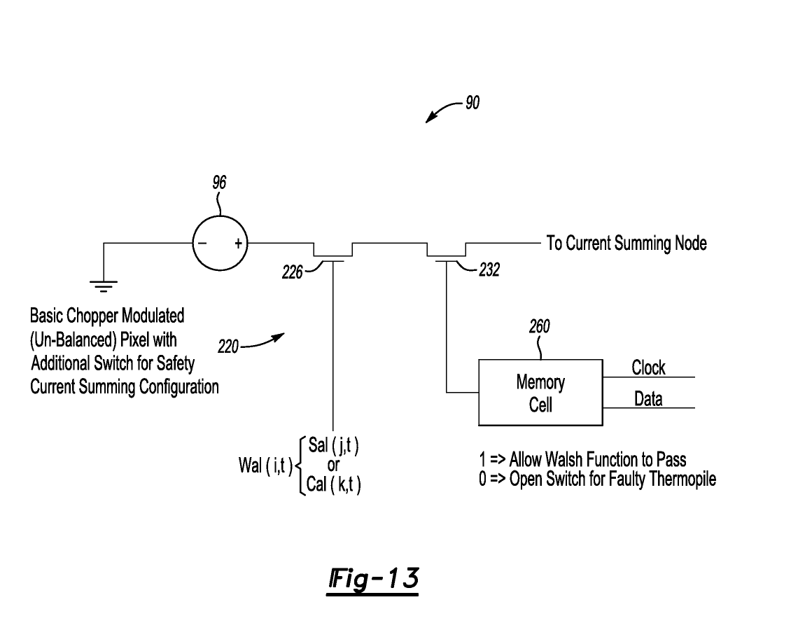

FIG. 13 depicts the thermopile 96 and the switching arrangement 220 for the current summing configuration of the array 76′ in accordance to one embodiment of the present disclosure. The pixel 90 as depicted in FIG. 13 is also generally indicative of the chopper modulated unbalanced pixel that is active half of the time.

The switching arrangement 220 includes the first switch 226 and the second switch 232. In order for the thermopile 96 to provide the modulated electrical output therefrom, the memory cell 260 provides high output and the state of the Walsh function is high output. As shown, when the Walsh function is high output and the memory cell 260 provides high output, the first switch 226 and the second switch 232 close thereby enabling the thermopile 96 to provide the modulated electrical output.

When the thermopile 96 is damaged, the memory cell 260 provides low output thereby opening the second switch 232 and disabling the thermopile 96 to ensure that additional pixels on the same row or column may still continue to provide the modulated electrical output.

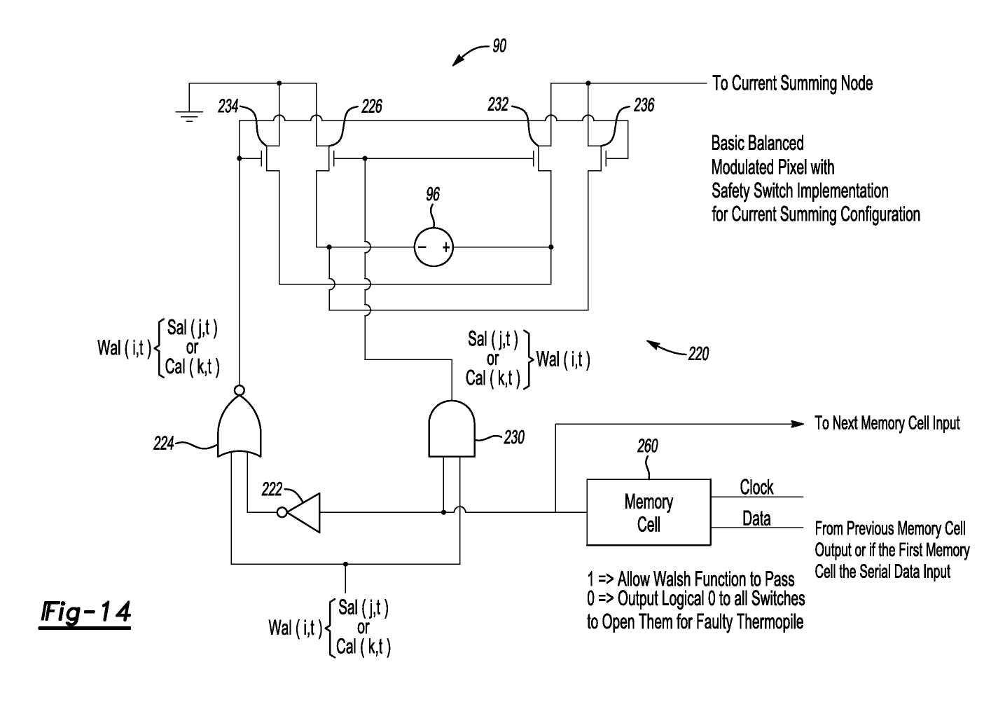

FIG. 14 depicts the thermopile 96 and the switching arrangement 220 for the current summing configuration of the array 76′ in accordance to one embodiment of the present disclosure. The pixel 90 as depicted in FIG. 14 is also generally indicative of a balanced modulated pixel. Because the pixel 90 is a balanced modulated pixel, it is active all of the time.

The switching arrangement 220 includes the first logic circuit 222, the second logic circuit 224, the fourth logic circuit 230, the first switch 226, the second switch 232, the third switch 234, and the fourth switch 236. For normal operation of the thermopile 96, the Walsh function is to be modulated on the electrical output of the pixel 90. In order for the thermopile 96 to provide the modulated electrical output therefrom, the memory cell 260 provides high output and the state of the Walsh function can either be high or low output.

For example, the forth logic circuit 230 receives high output from memory cell 260 and may receive high output from the Walsh function such that high output is provided therefrom. The first switch 226 and the second switch 232 are closed in response to high output from the fourth logic circuit 230. When the first switch 226 and the second switch 232 are closed, the thermopile 96 produces a forward polarity modulated electrical output. The second logic circuit 224 receives low output from the first logic circuit 222 and produces low output in response thereto. The third switch 234 and the fourth switch 236 are open in response to low output from the second logic circuit 224.

When the Walsh function provides low output, the fourth logic circuit 230 provides low output and the second logic circuit 224 produces high output. The first switch 226 and the second switch 232 are open in response to the low output from the fourth logic circuit 230, and the third switch 234 and the fourth switch 236 are closed in response to high output from the second logic circuit 224. When the third switch 234 and the fourth switch 236 are closed, the thermopile 96 produces a reverse polarity modulated electrical output.

When the thermopile 96 is damaged, it is necessary for the first switch 226, the second switch 232, the third switch 234 and the fourth switch 236 to be open such that the thermopile 96 is bypassed to enable the modulated electrical output from a previous pixel. To accomplish this, the memory cell 260 provides low output causing the fourth logic circuit 230 to produce low output (irrespective of state of Walsh function) and the second logic circuit 224 to produce low output (irrespective of state of Walsh function). A low output from the second logic circuit 224 and the fourth logic circuit 230 causes the first switch 226, the second switch 232, the third switch 234, and the fourth switch 236 to open thereby disabling the thermopile 96 to ensure that additional pixels on the same row or column may still continue to provide the modulated electrical output.

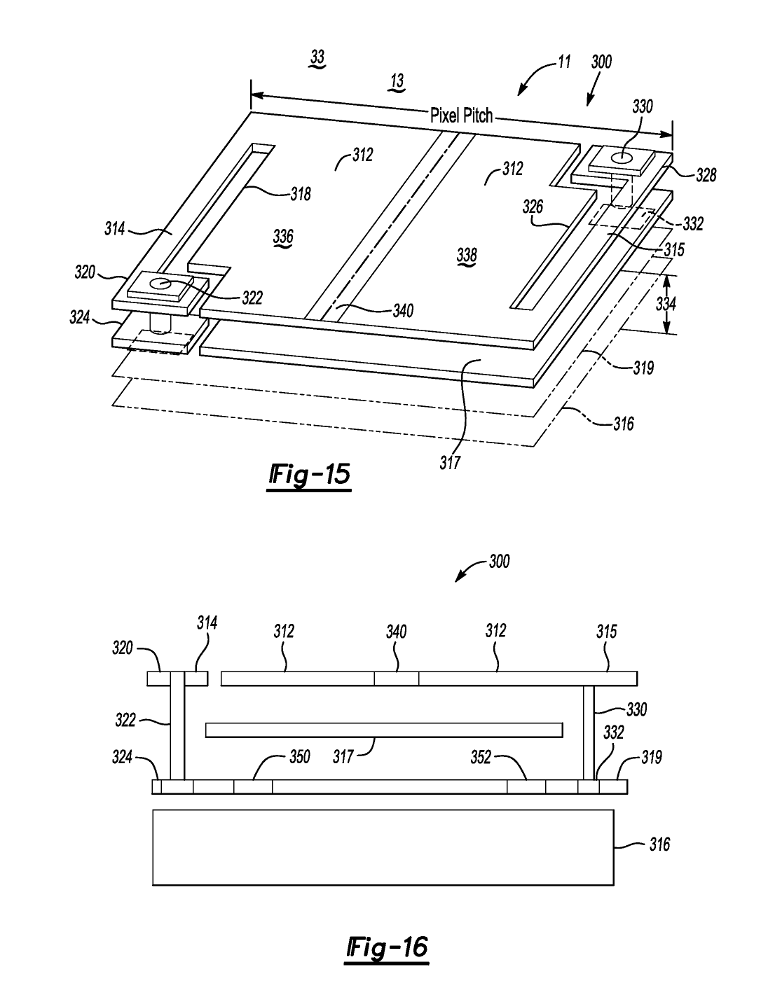

FIG. 15 depicts an elevated view of a thermal detector 300 in accordance to one embodiment of the present disclosure. FIG. 15 depicts a thermal detector (or sensor) 300 (or 70 as referenced above) in accordance to one embodiment of the present disclosure. The detector 300 may be one of many arranged in the M×N array 18 within the camera 11 that includes the lens 13. As noted above, the camera 11 is generally configured to capture an image of a scene and each detector 300 is configured to absorb IR radiation from a scene and to change its voltage potential based on the amount of energy received from the scene. A readout integrated circuit (ROIC) 319 (or readout circuit) is positioned below each detector 300. The ROIC 319 may electrically output the voltage potential for each detector 300. Each detector 300 may be micro-machined on top of the ROIC 319. The detector 300 is generally arranged as a micro-bridge. The detector 300 may be formed as a thermopile.

While the detector 300 as noted above may be used to capture an image of a scene in a camera, it is further contemplated that the detector 300 may be used to sense thermal energy from a light source (or scene), such as thermal energy received directly or indirectly from the sun. The detector 300 provides a voltage output in response to the thermal energy for providing electrical energy to power another device or for storing electrical energy on a storage device such as a battery or other suitable mechanism. An example of a detector 300 that provides a voltage output in response to the thermal energy to power another device or storing electrical energy on a storage device is set forth in co-pending PCT application Ser. No. ______ (“the '______ application”) (Attorney Docket No. UDH 0114 PCT), entitled “SUPERLATTICE QUANTUM WELL THERMOELECTRIC GENERATOR VIA RADIATION EXCHANGE AND/OR CONDUCTION/CONVECTION” filed on Apr. 10, 2013, which is hereby incorporated by reference in its entirety.

For example, the detector 300 as noted above may be one of many that are arranged in an array and may be used in connection with a ThermoElectric Generator (TEG) or a Radiative ThermoElectric Generator (RTEG) as disclosed in the '______ application.

The detector 300 includes an absorber 312, a first arm 314, a second arm 315, and a substrate 316. The absorber 312, the first arm 314, and the second arm 315 may comprise thermoelectric materials and be formed with superlattice quantum well materials as noted in connection with the '520 application above. The substrate 316 may comprise, but not limited to, a monocrystalline silicon wafer or a silicon wafer. The substrate 316 may be connected to the ROIC 319. The absorber 312, the first arm 314, and the second arm 315 are generally suspended over the ROIC 319. The first arm 314 is positioned next to the absorber 312 and may extend, if desired (attached or unattached) along a first side 318 of the absorber 312 and terminate at a terminal end 320. A post 322 is coupled to the terminal end 320 of the first arm 314.

An input pad 324 of the ROIC 319 receives the post 322. The post 322 provides an electrical connection from the absorber 312 to the ROIC 319. In a similar manner, the second arm 315 is positioned next to the absorber 312 and may extend, if desired (attached or unattached) along a second side 326 of the absorber 312 and terminate at a terminal end 328. A post 330 is coupled to the terminal end 328 of the second arm 315. An input pad 332 of the ROIC 319 receives the post 30. The post 330 provides an electrical connection from the absorber 312 to the ROIC 19. In general, the posts 322 and 330 cooperate with one another to support the absorber 312, the first arm 314, and the second arm 315 above the substrate 316 (e.g., suspend the absorber 312, the first arm 314, and the second arm 315 above the substrate 316).

The absorber 312 is generally configured to receive (or absorb) IR radiation from a scene and to change temperature in response thereto. The detector 300 may change its voltage potential based on the amount of radiation received from the scene. A reflector 317 is positioned between the absorber 312 and the ROIC 319. The reflector 317 may enhance the ability for the absorber 312 to absorb the IR radiation. For example, any thermal energy that is not absorbed by the absorber 312 may be received at the reflector 317 and reflected back to the absorber 312.

The first arm 314 and the second arm 315 may be horizontally displaced from the absorber 312 to thermally isolate the absorber 312. It may be desirable to reduce thermal conduction to increase detector 300 performance. In addition, the absorber 312, first arm 314, and the second arm 315 may be vertically displaced from the substrate 316 and define an isolation gap 334 (or cavity) therebetween for thermally isolating one detector from additional detectors positioned within the array.

The detector 300 may comprise P-type superlattice quantum well materials on one side and N-type superlattice quantum well materials on another side. For example, the absorber 312 may be considered to include a first portion 336, a second portion 338, and an active region 340. The first arm 314 and the first portion 336 may be constructed from P-type superlattice quantum well materials. The second arm 315 and the second portion 338 may be constructed from N-type superlattice quantum well materials. The active region 340 electrically couples the P-type based elements (first arm 314 and the first portion 336) to the N-type based elements (second arm 315 and the second portion 338).

Either the absorber 312 and/or the first and second arms 314, 315 may generate an electrical output that is indicative of the received thermal energy received at the thermopile. In some cases it may be desirable to include the superlattice quantum well materials on the first arm 314 and the second arm 315 and not on the absorber 312. In other cases, it may be desirable to include the superlattice quantum well materials on the first arm 314, the second arm 315, and the absorber 312. It is recognized that the size of the active region 340 on the absorber 312 will vary based on the amount of superlattice quantum well materials that are included on the absorber 312. For example, the active region 340 may comprise the entire absorber 312 in the event the superlattice quantum well materials are only provided on the first arm 314 and the second arm 315. Increased amounts of superlattice quantum materials deposited on the absorber 312 results in a decreased surface size of the active region 340 and vice versa. The active region 340 generally comprises a layer of gold or aluminum that may have one or more layers deposited thereon. This condition may be particularly useful for the TEG implementation.

FIG. 16 depicts a cross-sectional view of the thermal detector 300 in accordance to one embodiment of the present disclosure. The ROIC 319 generally includes a one or more switches 350 and various electronics 352 positioned therein. The switches 350 may include any of the switches as noted above which allow for modulation and/or bypass. For example, such switches 350 may include, but not limited to, the switches as noted in any one of FIGS. 5, 6, 8, 9, 10, 11, 12, 13, and 14, etc. Likewise the various electronics 352 may include the electrical devices of the above Figures which enable detector 300 bypass and/or modulation. For example, such electronics 352 may include memory cell(s), logic circuit(s), and shift register(s). In order to provide the proper data to the memory cell 260, a shift register may be implemented for each memory cell 260 of a detector by connecting an output from a memory cell to the next memory cell input and using a clock to shift a serial stream of digital data into the serial connected memory cells (see FIG. 14). As shown in FIG. 16, the ROIC 319 along with the switches 350 and the electronics 352 are positioned below the absorber 312 and the reflector 317. Such a condition may enable the packaging of the switches 350 and electronics 352 to be provided along with the detector 30 when implemented in the array 18.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the disclosure.

What is claimed is:

1. A sensing apparatus comprising:
a substrate;
a thermopile including an absorber positioned above the substrate for receiving thermal energy and for generating an electrical output indicative of the thermal energy; and
a readout circuit positioned below the absorber and including at least one first switch positioned thereon for being electrically coupled to the thermopile to provide a bypass in the event the thermopile is damaged.

2. The sensing apparatus of claim 1 wherein the thermopile further includes a first arm attached on a first side of the absorber and a second arm attached on a second side of the absorber.

3. The sensing apparatus of claim 2 wherein the first arm and the second arm are positioned above the read out circuit.

4. The sensing apparatus of claim 1 wherein the at least one first switch is further configured to modulate the electrical output from the thermopile.

5. The sensing apparatus of claim 4 wherein the readout circuit further includes at least one of a memory cell and a logic circuit positioned therein for enabling one of the bypass and modulation of the electrical output from the thermopile.

6. The sensing apparatus of claim 1 wherein the at least one first switch further includes a second switch configured to modulate the electrical output from the thermopile.

7. A sensing apparatus comprising:
a substrate;
a thermopile including a first arm and a second arm positioned above the substrate for receiving thermal energy and for generating an electrical output indicative of the thermal energy; and
a readout circuit positioned below the first arm and the second arm and including at least one first switch positioned thereon for being electrically coupled to the thermopile to provide a bypass in the event the thermopile is damaged.

8. The sensing apparatus of claim 7 wherein the thermopile further includes an absorber attached to the first arm and the second arm.

9. The sensing apparatus of claim 8 wherein the absorber is positioned above the readout circuit.

10. The sensing apparatus of claim 7 wherein the at least one first switch is further configured to modulate the electrical output from the thermopile.

11. The sensing apparatus of claim 10 wherein the readout circuit further includes at least one of a memory cell and a logic circuit for enabling one of the bypass and modulation of the electrical output from the thermopile.

12. The sensing apparatus of claim 7 wherein the at least one first switch further includes a second switch configured to modulate the electrical output from the thermopile.

13. A sensing apparatus comprising:
a substrate;
a thermopile positioned above the substrate for receiving thermal energy and for generating a electrical output indicative of the thermal energy; and
a readout circuit positioned below the thermopile and including at least one first switch positioned therein for being electrically coupled to the thermopile to modulate the electrical output to provide a modulated electrical output.

14. The sensing apparatus of claim 13 wherein the thermopile includes an absorber, a first arm, and a second arm, and wherein the first arm and the second arm are attached to the absorber.

15. The sensing apparatus of claim 14 wherein the absorber is positioned above the read out circuit.

16. The sensing apparatus of claim 13 wherein the at least one first switch is further configured to provide a bypass in the event thermopile is damaged.

17. The sensing apparatus of claim 18 wherein the readout circuit further includes at least one of a memory cell and a logic circuit for enabling one of the bypass and modulation of the electrical output from the thermopile.

18. The sensing apparatus of claim 13 wherein the at least one first switch further includes a second switch configured to provide a bypass in the event the thermopile is damaged.
